(19) United States
(12) Patent Application Publication
(10) Pub. No.: US 2018/0300065 A1
(43) Pub. Date: Oct. 18, 2018

(54) STORAGE RESOURCE MANAGEMENT EMPLOYING END-TO-END LATENCY ANALYTICS

(71) Applicant: Nutanix, Inc., San Jose, CA (US)

(72) Inventors: Vanish Talwar, Campbell, CA (US); Gokul Nadathur, Fremont, CA (US)

(21) Appl. No.: 15/488,503

(22) Filed: Apr. 16, 2017

(51) Int. Cl. G06F 3/06; G06F 12/0866; G06F 9/455

(52) U.S. Cl. CPC G06F 3/0611; G06F 12/0866; G06F 3/0667; G06F 2009/4557; G06F 3/0688; G06F 2212/222; G06F 2009/45583; G06F 9/45558

(57) ABSTRACT

Performance of a computing system is improved by identifying and mitigating a bottleneck along a path that spans a storage system and a virtual machine causing the bottleneck. A mitigation action is selected and performed according to the bottleneck location. To identify a virtual machine involved in the bottleneck, end-to-end latency values connected with individual virtual machines are used, some of which are estimated using the presently disclosed techniques. Specifically, a backend storage latency from a specific virtual machine, and a flash virtualization platform, network, and queuing latency for the virtual machine are not conventionally observable, but are instead estimated using other readily available usage statistics.

### BACKGROUND

### Field

This non-provisional U.S. patent application relates generally to storage resource management in computing systems and more specifically to those employing latency analytics.

### Description of Related Art

Certain computing architectures include a set of computing systems coupled through a data network to a set of storage systems. The computing systems provide computation resources and are typically configured to execute applications within a collection of virtual machines. A hypervisor is typically configured to provide run time services to the virtual machines and record operational statistics for the virtual machines. The storage systems are typically configured to present storage resources to the virtual machines and to record overall usage statistics for the storage resources.

One or more virtual machines can access a given storage resource through a storage data network or fabric. Under certain conditions, a storage resource can exhibit increased latency, which can lead to performance degradation. Identifying the underlying cause for the increased latency can facilitate mitigating the cause and restoring proper system operation.

One common underlying cause is that a particular virtual machine starts generating access requests having a character (e.g., large block size, high request rate, high interference rate) that causes latency to increase in the storage resource. However, access requests arriving at the storage resource do not conventionally indicate which virtual machine generated the requests. Consequently, managing storage systems to avoid performance degradation due to latency increases is not conventionally feasible because identifying an underlying cause of increased latency is not conventionally feasible. What is needed therefore is an improved technique for managing storage systems.

### SUMMARY

According to various embodiments, a method comprising: calculating, by a storage resource manager, an average virtual machine (VM) latency value for a system stage, wherein calculating the average VM latency value comprises: determining VM latency values for different block sizes using workload signature values for the block sizes and average latency values for the block sizes; and calculating a sum of products using the VM latency values for different block sizes and the workload signature values for the block sizes as product terms; identifying, by the storage resource manager, that the system stage is a bottleneck in response to calculating the average VM latency value; selecting, by the storage resource manager, a mitigation action based on the identified system stage; and directing, by the storage resource manager, the mitigation action in response to the bottleneck being identified.

According to various further embodiments, an apparatus comprising: a processing unit in communication with a storage controller, the processor configured to: calculate an average virtual machine (VM) latency value for a system stage, wherein to calculate the average VM latency value, the processing unit is configured to: determine VM latency values for different block sizes using workload signature values for the block sizes and average latency values for the block sizes; and calculate a sum of products using the VM latency values for different block sizes and the workload signature values for the block sizes as product terms; identify that the system stage is a bottleneck in response to calculating the average VM latency value; select a mitigation action based on the identified system stage; and direct, by the storage resource manager, the mitigation action in response to the bottleneck being identified.

According to various still further embodiments, a non-transitory computer readable storage medium, including programming instructions stored therein that, when executed by a processing unit, cause the processing unit to: calculate an average virtual machine (VM) latency value for a system stage, wherein to calculate the average VM latency value, the processing unit is configured to: determine VM latency values for different block sizes using workload signature values for the block sizes and average latency values for the block sizes; and calculate a sum of products using the VM latency values for different block sizes and the workload signature values for the block sizes as product terms; identify that the system stage is a bottleneck in response to calculating the average VM latency value; select a mitigation action based on the identified system stage; and direct, by the storage resource manager, the mitigation action in response to the bottleneck being identified.

### BRIEF DESCRIPTION OF THE DRAWINGS

FIG. 1 is a block diagram of a portion of a computing system operating environment in which various embodiments can be practiced.

FIG. 2 is a block diagram of an exemplary storage system in which various embodiments can be practiced.

FIG. 3 illustrates latency metrics in a computing environment, according to some embodiments.

FIG. 4 illustrates organizing latency data for estimating latency in a system stage for a specified virtual machine, according to some embodiments.

FIG. 5 is a flow chart of a method for estimating latency for a specified virtual machine, according to some embodiments.

FIG. 6 is a flow chart of a method for managing storage resources using an estimated latency for a specified virtual machine, according to some embodiments.

### DETAILED DESCRIPTION

In typical system architectures, computing systems generate a workload (i.e., read and/or write requests per second) that is serviced by a storage controller within a storage system. Multiple storage clients (e.g., virtual machines, software applications, etc.) can contribute to the workload of the storage system, and certain storage clients can generate various types of workloads that can cause performance degradation of other storage clients. In certain scenarios, virtual machine storage I/O latencies can increase due to various factors, in one or more locations within an end-to-end path leading from a virtual machine to a storage resource within the storage system. For example, latency can increase at various stages within a host computing system due to overloading in the host computing system or increased queuing within host queues. Latency can also increase at a storage system backend due to overload or interference from I/O requests arriving from different virtual machines.

In the context of the present disclosure, a storage resource can include, without limitation, a block storage container such as a storage logical unit number (LUN), an arbitrary set of individual storage blocks, a datastore such as a VMware ESX™ datastore, one or more storage volumes, a virtual disk (e.g., a VMware™ vDisk), a stored object, or a combination thereof.

System operation is improved by identifying a virtual machine responsible for increased latency and performing a mitigation action to resolve the increased latency. Exemplary mitigation actions can include, without limitation, activating a system cache to cache data requests associated with a specified virtual machine, activating rate limiting on a specified virtual machine, migrating a specified virtual machine, increasing queue size (e.g., in a host adapter and/or in the storage system), and migrating a storage resource targeted by a specified virtual machine to a different storage system or storage controller.

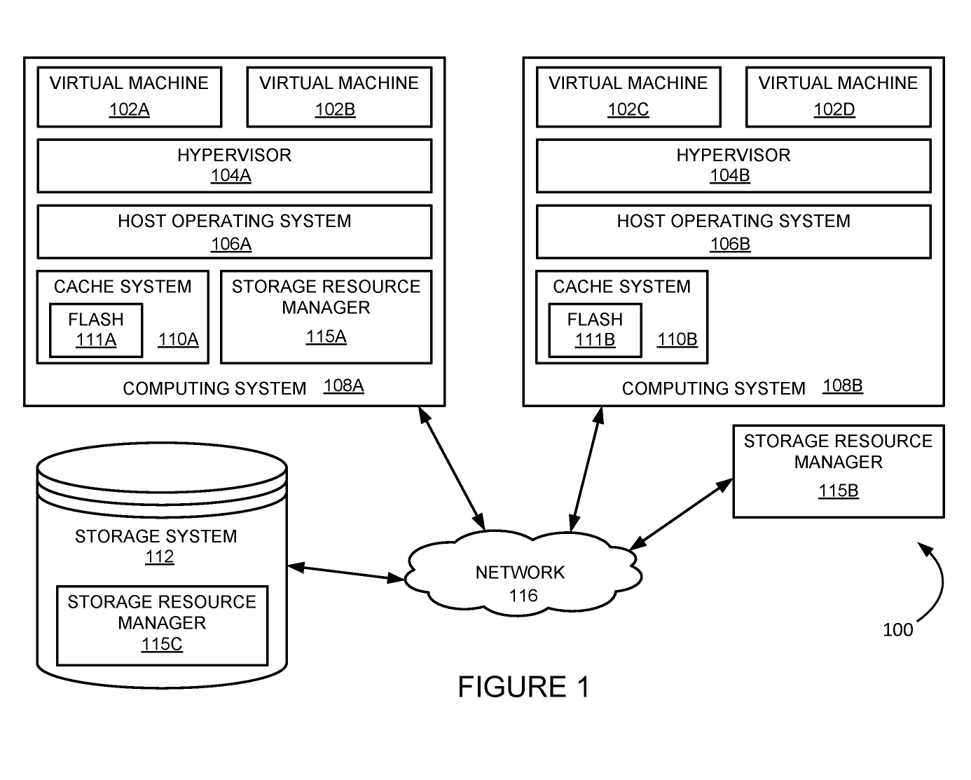

Performance degradation of a storage resource may have as an underlying cause one or more virtual machines generating traffic targeting the storage resource, or potentially an unrelated cause in the system. Measuring latency in the various stages of the system from the virtual machine all the way to physical storage media can help identify where latency has increased above a baseline or increased above a threshold. In one embodiment, identifying a latency increase in a certain part of the system can be used to select a mitigation action to address potential bottlenecks caused by the latency. Embodiments of the present disclosure provide techniques for estimating latency in a stage of the system that is not directly observable in conventional systems. More specifically, latency for a given stage of the system for a given virtual machine can be estimated from a combination of aggregate latency data at the storage resource and a workload profile for the virtual machine. In other words, directly observable latency values in combination with the inferred access latency can be used to estimate latency at a given stage in the system. The techniques are described herein with respect to the systems of FIGS. 1-3, however any computing environment with corresponding stages is within the scope and spirit of the present disclosure.

FIG. 1 is a block diagram of a portion of a computing system operating environment 100 in which various embodiments can be practiced. Referring first to computing system 108A on the left, the environment 100 comprises one or more virtual machines 102 (denoted 102A & 102B in the figure, and wherein each virtual machine can itself be considered an application) executed by a hypervisor 104A. The hypervisor 104A is executed by a host operating system 106A (which may itself include the hypervisor 104A) or may execute in place of the host operating system 106A. The host operating system 106A resides on the physical computing system 108A having a cache system 110A. The cache system 110A includes operating logic to cache data within a local memory. The local memory is a faster, more expensive memory such as Dynamic Random Access Memory (DRAM) or persistent devices such as flash memory 111A. The environment 100 can include multiple computing systems 108, as is indicated in the figure by computing system 108A and computing system 108B. Each of computing system 108A and 108B is configured to communicate across a network 116 with a storage system 112 to store data. Network 116 is any known communications network including a local area network, a wide area network, a proprietary network or the Internet. The storage system 112 is typically a slower memory, such as a Solid State Drive (SSD) or hard disk. The environment 100 can include multiple storage systems 112. Examples of storage system 112 include, but are not limited to, a storage area network (SAN), a local disk, a shared serial attached “small computer system interface (SCSI)” (SAS) box, a network file system (NFS), a network attached storage (NAS), an internet SCSI (iSCSI) storage system, and a Fibre Channel storage system.

Referring to either of computing system 108A or 108B, when a virtual machine 102 generates a read command or a write command, the application sends the generated command to the host operating system 106. The virtual machine 102 includes, in the generated command, an instruction to read or write a data record at a specified location in the storage system 112. When activated, cache system 110 receives the sent command and caches the data record and the specified storage system memory location. As understood by one of skill in the art, in a write-through cache system, the generated write commands are simultaneously sent to the storage system 112. Conversely, in a write-back cache system, the generated write commands are subsequently sent to the storage system 112 typically using what is referred to herein as a destager.

In some embodiments of the present approach, and as would be understood by one of skill in the art in light of the teachings herein, the environment 100 of FIG. 1 can be further simplified to being a computing system running an operating system running one or more applications that communicate directly or indirectly with the storage system 112.

As stated above, cache system 110 includes various cache resources. In particular and as shown in the figure, cache system 110 includes a flash memory resource 111 (e.g., 111A and 111B in the figure) for storing cached data records. Further, cache system 110 also includes network resources for communicating across network 116.

Such cache resources are used by cache system 110 to facilitate normal cache operations. For example, virtual machine 102A may generate a read command for a data record stored in storage system 112. As has been explained and as understood by one of skill in the art, the data record is received by cache system 110A. Cache system 110A may determine that the data record to be read is not in flash memory 111A (known as a “cache miss”) and therefore issue a read command across network 116 to storage system 112. Storage system 112 reads the requested data record and returns it as a response communicated back across network 116 to cache system 110A. Cache system 110A then returns the read data record to virtual machine 102A and also writes or stores it in flash memory 111A (in what is referred to herein as a “false write” because it is a write to cache memory initiated by a generated read command versus a write to cache memory initiated by a generated write command which is sometimes referred to herein as a “true write” to differentiate it from a false write).

Having now stored the data record in flash memory 111A, cache system 110A can, following typical cache operations, now provide that data record in a more expeditious manner for a subsequent read of that data record. For example, should virtual machine 102A, or virtual machine 102B for that matter, generate another read command for that same data record, cache system 110A can merely read that data record from flash memory 111A and return it to the requesting virtual machine rather than having to take the time to issue a read across network 116 to storage system 112, which is known to typically take longer than simply reading from local flash memory.

Likewise, as would be understood by one of skill in the art in light of the teachings herein, virtual machine 102A can generate a write command for a data record stored in storage system 112 which write command can result in cache system 110A writing or storing the data record in flash memory 111A and in storage system 112 using either a write-through or write-back cache approach.

Still further, in addition to reading from and/or writing to flash memory 111A, in some embodiments cache system 110A can also read from and/or write to flash memory 111B and, likewise, cache system 110E can read from and/or write to flash memory 111B as well as flash memory 111A in what is referred to herein as a distributed cache memory system. Of course, such operations require communicating across network 116 because these components are part of physically separate computing systems, namely computing system 108A and 108B. In certain embodiments, cache system 110 can be optionally activated or deactivated. For example, cache system 110 can be activated to cache I/O requests generated by a specified virtual machine 102, or I/O requests targeting a specific storage resource within the storage system 112. When activated, cache system 110 can serve to mitigate latency and performance impacts of one or more storage client bullies or one or more storage resources. In other embodiments, cache system 110 is not included within a computing system 108.

The storage system 112 is configured to receive read and write I/O requests, which are parsed and directed to storage media modules (e.g., magnetic hard disk drives, solid-state drives, flash storage modules, phase-change storage devices, and the like). While no one storage media module is necessarily designed to service I/O requests at an overall throughput level of storage system 112, a collection of storage media modules can be configured to generally provide the required overall throughput. However, in certain scenarios, I/O requests from multiple storage clients can disproportionately target one or a few storage media modules, leading to a bottleneck and a significant increase in overall system latency. Similarly, I/O requests can disproportionately target different system resources, such as controller processors, I/O ports, and internal channels, causing interference among the I/O requests. Such interference among I/O requests contending for the same system resource can lead to degraded performance and elevated latency. In one embodiment, the storage subsystem 112 presents storage blocks residing within the storage media modules as one or more LUNs, with different LUNs presenting a range of numbered storage blocks. A given LUN can be partitioned to include one or more different virtual disks (vDisks) or other storage structures. As defined herein, a given LUN can be considered a storage resource, and a given vDisk residing within the LUN can be considered a separate storage resource.

In one embodiment, multiple vDisks are assigned to reside within a first LUN that is managed by a first storage controller. Furthermore, the LUN and the vDisks are configured to reside within the same set of storage media modules. In a scenario where a storage client bully begins intensively accessing one of the vDisks in the LUN, other vDisks in the LUN can potentially suffer performance degradation because the different vDisks share the same storage media modules providing physical storage for the LUN. In certain cases, other unrelated LUNs residing on the same storage media modules can also suffer performance degradation. Similarly, otherwise unrelated LUNs sharing a common storage controller can suffer performance degradation if the storage client bully creates a throughput bottleneck or stresses overall performance of the common storage controller.

In one embodiment, the storage subsystem 112 is configured to accumulate usage statistics, including read and write statistics for different block sizes for specified storage resources, latency statistics for different block sizes of the specified storage resources, and the like. For example, the storage subsystem 112 can be configured to accumulate detailed and separate usage statistics for different LUNs residing therein. In one embodiment, a virtual machine run time system is configured to similarly track access statistics generated by virtual machines 102 executing within the run time system.

In one embodiment, a storage resource manager 115A is configured to generate latency values, performance utilization values, or a combination thereof for one or more storage system 112 and perform system management actions according to the latency values. The resource manager 115A can be implemented in a variety of ways known to those skilled in the art including, but not limited to, as a software module executing within computing system 108A. The software module may execute within an application space for host operating system 106A, a kernel space for host operating system 106A, or a combination thereof. Similarly, storage resource manager 115A may instead execute as an application within a virtual machine 102. In another embodiment, storage resource manager 115A is replaced with storage resource manager 115B, configured to execute in a computing system that is independent of computing systems 108A and 108B. In yet another embodiment, storage resource manager 115A is replaced with a storage resource manager 115C configured to execute within a storage system 112.

In one embodiment, a given storage resource manager 115 includes three sub-modules. A first sub-module is a data collection system for collecting IOPS, workload profile, and latency data; a second sub-module is a latency diagnosis system; and, a third sub-module is a mitigation execution system configured to direct or perform mitigation actions such as migration to overcome an identified cause of a latency increase. The first (data collection) sub-module is configured to provide raw usage statistics data for usage of the storage system. For example, the raw usage statistics data can include workload profiles (accumulated I/O request block size distributions) for different virtual machines, and end-to-end latencies for the virtual machines. In one embodiment, a portion of the first sub-module is configured to execute within storage system 112 to collect raw usage statistics related to storage resource usage, and a second portion of the first sub-module is configured to execute within computing systems 108 to collect raw usage statistics related to virtual machine resource usage. In one embodiment, the raw usage statistics include latency values for different read I/O request block sizes and different write I/O request block sizes of the storage system 112. The second (latency diagnosis) sub-module is configured to determine which virtual machine is responsible for causing an increase in latency and/or where the increase in latency is occurring. In one embodiment, the second sub-module is implemented to execute within a computing system 108 (within storage resource manager 115A), an independent computing system (within storage resource manager 115B) or within storage system 112 (within storage resource manager 115C). The third (mitigation execution) sub-module is configured to receive latency diagnosis output results of the second sub-module, and respond to the output results by directing or performing a system management action as described further elsewhere herein.

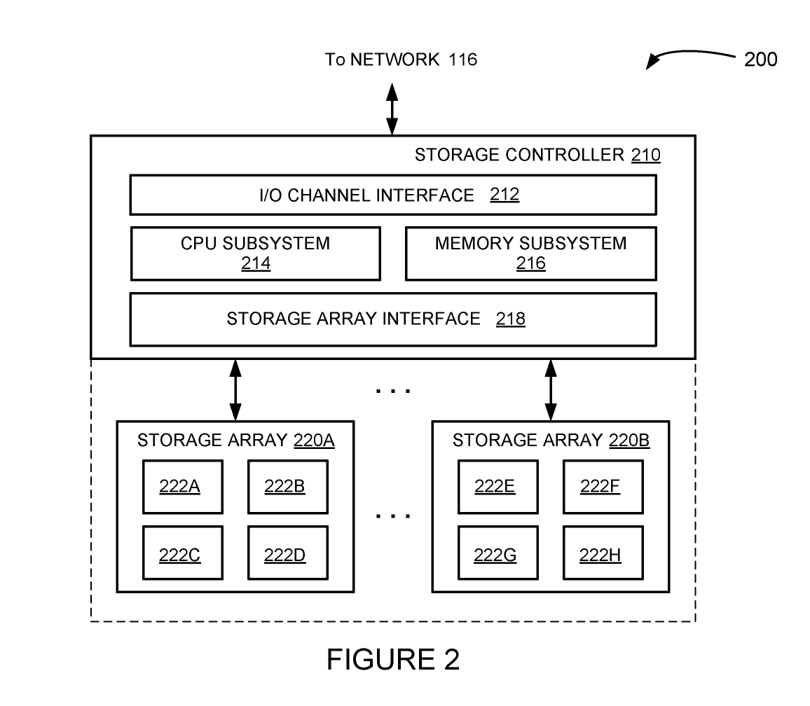

FIG. 2 is a block diagram of an exemplary storage system 200 in which various embodiments can be practiced. In one embodiment, storage system 112 of FIG. 1 includes at least one instance of storage system 200. As shown, storage system 200 comprises a storage controller 210 and one or more storage array 220 (e.g., storage arrays 220A and 220B). Storage controller 210 is configured to provide read and write access to storage resources 222 residing within a storage array 220. In one embodiment, storage controller 210 includes an input/output (I/O) channel interface 212, a central processing unit (CPU) subsystem 214, a memory subsystem 216, and a storage array interface 218. In certain embodiments, storage controller 210 is configured to include one or more storage arrays 220 within an integrated system. In other embodiments, storage arrays 220 are discrete systems coupled to storage controller 210.

In one embodiment, I/O channel interface 212 is configured to communicate with network 116. CPU subsystem 214 includes one or more processor cores, each configured to execute instructions for system operation such as performing read and write access requests to storage arrays 220. A memory subsystem 216 is coupled to CPU subsystem 214 and configured to store data and programming instructions. In certain embodiments, memory subsystem 216 is coupled to I/O channel interface 212 and storage array interface 218, and configured to store data in transit between a storage array 220 and network 116. Storage array interface 218 is configured to provide media-specific interfaces (e.g., SAS, SATA, etc.) to storage arrays 220.

Storage controller 210 accumulates raw usage statistics data and transmits the raw usage statistics data to a storage resource manager, such as storage resource manager 115A, 115B, or 115C of FIG. 1. In particular, the raw usage statistics data can include independent IOPS and latency values for different read I/O request block sizes and different write I/O request block sizes. A given mix of different read I/O request block sizes and different write I/O request block sizes accumulated during a measurement time period characterizes a workload presented to storage controller 210. Furthermore, the storage resource manager processes the raw usage statistics data to generate a workload profile for the storage controller.

In one embodiment, the workload profile includes aggregated access requests generated by a collection of one or more storage clients directing requests to various storage resources 222 residing within storage controller 210. Exemplary storage clients include, without limitation, virtual machines 102. As the number of storage clients increases and the number of requests from the storage clients increases, the workload for storage controller 210 can increase beyond the ability of storage controller 210 to service the workload, which is an overload condition that results in performance degradation that can impact multiple storage clients. In certain scenarios, an average workload does not generally create an overload condition; however, a workload increase from one or more storage client bullies (e.g., noisy neighbors) create transient increases in workload or request interference, resulting in latency increases and/or performance degradation for other storage clients. In certain settings where different virtual machines 102 are configured to share a computing system 108 and/or storage system 112 one virtual machine 102 that is a noisy neighbor can become a storage client bully and degrade performance in most or all of the other virtual machines 102.

System operation is improved by relocating storage resources among different instances of storage controller 210 and/or storage system 200. A storage resource that exhibits excessive usage at a source storage controller can be moved to a destination storage controller to reduce latency at the source storage controller while not overloading the destination storage controller.

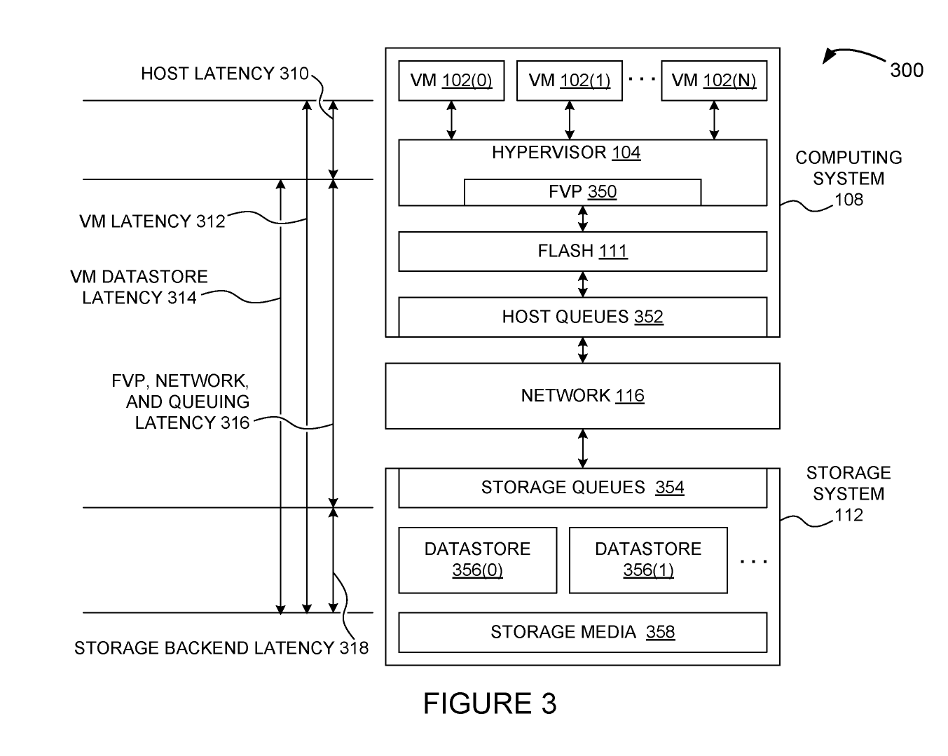

FIG. 3 illustrates latency metrics in a computing environment 300, according to some embodiments. In one embodiment, computing environment 300 corresponds to environment 100 of FIG. 1. Virtual machines (VMs) 102 operate in a managed runtime environment provided by hypervisor 104, and execute within computing system 108. A flash virtualization platform (FVP) 350 provides I/O interceptor services within the hypervisor 104. The I/O interceptor services provided by FVP 350 can facilitate, without limitation, system monitoring, gathering usage statistics, modular addition of other I/O interceptor functions, and caching of I/O data storage requests. The computing environment 300 described herein can operate with or without an FVP 350 module, and various operations such as caching and/or system monitoring can also be implemented separately without the FVP 350. In one embodiment, the FVP 350 provides a flash memory abstraction to the hypervisor 104, and can include operational features of cache 110. In one embodiment, FVP 350 is implemented as a kernel module within hypervisor 104. FVP 350 is coupled to a flash subsystem 111, which is configured to include banks of flash memory devices and/or other solid-state, non-volatile storage media. The flash subsystem 111 provides high-speed memory resources to the hypervisor 104 and/or FVP 350.

A set of host queues 352 is configured to receive access requests from flash subsystem 111. The access requests are transmitted through network 116 to storage system 112. In one embodiment, a given access request targets a specified datastore 356 residing within storage system 112. The access request is queued into storage queues 354, along with potentially other requests, at storage system 112. The access request causes the storage system 112 to generate a corresponding read or write operation to storage media 358, which comprises storage media modules configured to provide physical storage of data for the datastores 356. One or more datastores 356 may reside within one or more storage resources 222 of FIG. 2. In certain configurations a datastore 356 operates as a storage resource 222.

A given access request generated by a virtual machine 102 traverses a path that can include multiple system stages, including the hypervisor 104, FVP 350, flash subsystem 111, host queues 352, and so forth all the way to storage media 358 and back. Different stages in the system can impart a corresponding latency. A given access request traverses from the virtual machine 102 to a system stage that produces a reply. Latency for a given system stage includes processing and/or queuing time contributed by the system stage for a round-trip response for the access request. In certain situations, an access request can be completed using cached data at a certain system stage without having to transmit the access request all the way to storage media 358.

As shown, a host latency 310 indicates latency between virtual machines 102 and an FVP access point for the FVP 350 within the hypervisor 104. A virtual machine (VM) latency 312 indicates latency between virtual machines 102 and a storage media 358. A virtual machine datastore latency 314 indicates latency between the FVP access point and the storage media 358, in which a target datastore 356 or other storage resource resides. An FVP, network, and queuing latency 316 indicates latency that includes the FVP 350 stage, a network 116 stage, and queuing stages (e.g., host queues 352 and/or storage queues 354, and optionally, other intermediary queues that are not shown) of computing environment 300, defined between the FVP access point and a datastore 356.

Certain latency values can be conventionally measured with respect to a specific virtual machine 102. For example, virtual machine latency 312 can be directly observed and measured at a given virtual machine 102. However, certain other latency values can only be conventionally measured in aggregate with no connection to a specific virtual machine. For example, storage backend latency 318 is conventionally measured as an aggregate latency value without regard to specific virtual machines 102 because no identifying information connecting a specific virtual machine 102 is conventionally included in arriving requests for a read or write operation. Similarly, FVP, network, and queuing latency 316 is conventionally measured as an aggregate latency without regard to specific virtual machines 102, again because no identifying information connecting a specific virtual machine 102 to a queue entry is conventionally available. However, backend latency 318 for only those requests from a specified virtual machine 102 (VM backend latency) or FVP, network, and queuing latency 316 for only those requests from the specified virtual machine (VM FVP, network, and queuing latency) can be useful for selecting an effective mitigation strategy.

Techniques described herein provide for estimating VM backend latency as well as VM FVP, network, and queuing latency, using VM datastore latency 314 with block size breakdowns, VM workload datastore I/O frequency counts with block size breakdowns (VM workload signatures), and storage backend latencies 318 for different datastores 356 with block size breakdowns.

In one embodiment, VM workload signature values (with block size break down) are generated from a workload profile collected for a selected virtual machine 102 of FIG. 1. The VM workload signature values are defined herein to be ratios for different block sizes of a total storage request count for storage requests generated by a particular virtual machine within a given measurement time period. For example, if ten percent of storage requests generated by the virtual machine have a block size of 4K, then a VM workload signature value for a 4K block size is equal to one tenth (0.10). In one embodiment, VM workload signature values are calculated using workload profile values for read, write, or a combination of read and write workload profile values for the selected virtual machine 102.

In one embodiment, VM datastore latency 314 with block size breakdowns, VM workload datastore I/O frequency counts with block size breakdowns (VM workload signatures), and storage backend latencies 318 for different datastores 356 with block size breakdowns are measured within a measurement time period, as described herein. In other embodiments, different measurement time periods can be implemented without departing from the scope and spirit of the present disclosure.

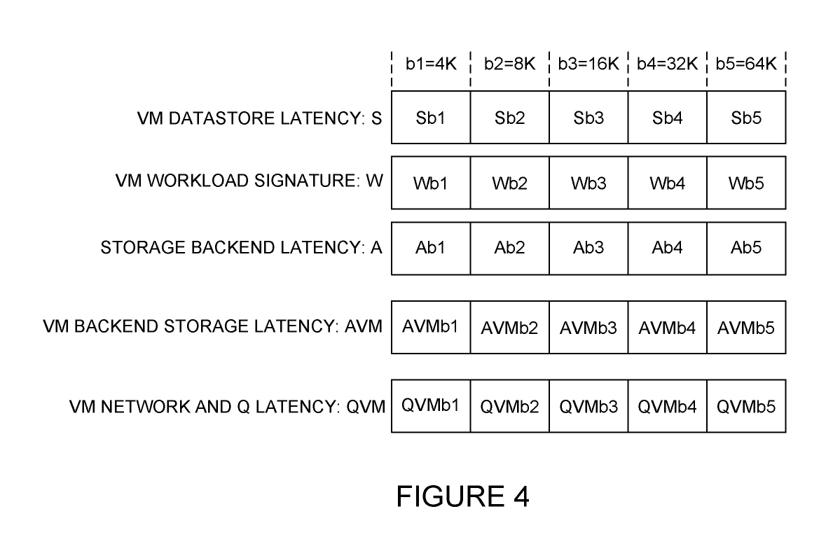

FIG. 4 illustrates organizing latency data for estimating latency in a system stage for a specified virtual machine, according to some embodiments. An exemplary block size breakdown is indicated as columns for b1 through b5. Different or additional block size breakdowns can also be implemented, for example to include block sizes ranging from four kilobytes (4K) through two megabytes (2M).

A VM datastore latency 314 (S) block size breakdown is shown as Sb1 through Sb5, with VM datastore latency for 4K blocks indicated as Sb1 and VM datastore latency for 64K blocks indicated as Sb5. A VM workload signature block size breakdown is shown as Wb1 through Wb5, with a VM workload signature value for 4K blocks indicated as Wb1 and a VM workload signature value for 64K blocks indicated as Wb5. A storage backend latency 318 (A) block size breakdown is shown as Ab1 through Ab5, with storage backend latency for 4K blocks indicated as Ab1 and storage back and latency for 64K blocks indicated as Ab5.

A VM backend storage latency value (AVM) is determined, in this example, for block sizes b1 (4K) through b5 (64K). A VM backend storage latency value (AVM) is defined as a latency value for access requests generated by a selected virtual machine 102 traversing a path of the storage backend latency 318. To determine an AVM value for a given block size, the AVM value for the block size is assigning a value of zero if the VM workload signature value (W) for the block size is zero otherwise it is assigned a value of the storage backend latency (A) for the block size. For example, if Wb1 is equal to zero, then AVMb1 is set to zero; otherwise, if Wb1 is not equal to zero, then AVMb1 is set equal to Ab1. Continuing the example, if Wb5 is equal to zero, then AVMb5 is set to zero, otherwise AVMb5 is set equal to AB5. In this way, AVMb1 through AVMb5 are determined. A zero latency value in this context does not indicate zero latency for actual requests of a certain block size, but instead indicates no requests were observed from the selected virtual machine 102 for the block size during the measurement time period and prepares the latency values for a weighted sum calculation to follow. By assigning VM backend storage latency values in this way, an approximation of actual VM backend storage latency values for different block sizes for a selected virtual machine 102 can be determined. Using this approximation, an average VM backend storage latency can be calculated individually for different virtual machines 102. Furthermore, a virtual machine 102 implicated in an increase in backend storage latency 318 or FVP, networking, and queuing latency 316 can be identified as a target for different potential mitigation actions.

In one embodiment, an average VM backend storage latency for a selected virtual machine 102 is calculated as a weighted sum of products, with the summation operation taken for different block sizes. For a given block size (k) in the summation operation, a product term is calculated by multiplying a VM workload signature value for the block size (Wbk) by a VM backend storage latency value for the block size (AVMk). For example, if a given virtual machine 102 generates storage requests with 4K block size requests comprising 80% of total storage requests and 64 K block size requests comprising 20% of total storage requests, then Wb1 is equal to 0.80, Wb5 is equal to 0.20, and Wb2 through Wb4 are equal to zero (0.00). Continuing the example, if a target datastore 356 has a storage backend latency (A) of 1 ms for 4K block size requests (Ab1=1 ms), 2 ms for 8K block size requests, 3 ms for 16K block size request, 4 ms for 32K block size requests, and 5 ms for 64K block size requests (Ab5=5 ms), then AVMb1 is equal to 1 ms (because Wb1 is not equal to 0.00), AVMb2 is equal to 0 ms (because Wb2 is equal to 0.00), AVMb3 is equal to 0 ms (Wb3 is equal to 0.00), AVMb4 is equal to 0 ms (Wb4 is equal to 0.00), and AVMb5 is equal to 5 ms (Wb1 is not equal to 0.00). In this example, the average VM backend storage latency for the virtual machine 102 is calculated by the weighted sum (0.80*1 ms)+(0.20*5 ms), which is equal to 1.8 ms. Storage requests and latencies for 8K through 32K block sizes are observed at the target datastore 356, but are due to storage clients other than the virtual machine 102.

In one embodiment, an average VM FVP, network, and queuing value is defined as an average latency value for access requests generated by a selected virtual machine 102 traversing a path of the FVP, networking, and queuing latency 316. The average VM FVP, network, and queuing latency for a selected virtual machine 102 is calculated as a weighted sum of products, with the summation operation taken for different block sizes. For a given block size (k) in the summation operation, a product term is calculated by multiplying a VM workload signature value for the block size (Wbk) by a VM FVP, network, and queuing latency value for the block size (QVMbk). The VM FVP, network, and queuing latency value for the block size (QVMbk) is calculated by subtracting a VM backend storage latency value for the block size (AVMbk) from a VM datastore latency 314 value for the block size (Sbk). In other words, for a 4K block size, a VM FVP, network, and queuing latency value (QVMb1) is calculated as Sb1 minus AVMb1. Continuing the example provided herein, if VM datastore latency (S) is 3 ms for 4K block size requests (Sb1=3 ms) and 8 ms for 64K block size requests (Sb5=8 ms), then QVMb1 is equal to 2 ms, calculated as Sb1 (3 ms) minus Ab1 (1 ms); and QVMb5 is equal to 3 ms, calculated as Sb5 (8 ms) minus Ab5 (5 ms). In this example, the average VM FVP, network, and queuing value is equal to 2.2 ms, calculated as QVMb1*Wb1+QVMb5*Wb5 (2 ms*0.8+3 ms*0.2).

An average VM FVP, network, and queuing latency value can be calculated individually for different virtual machines 102. Furthermore, a virtual machine 102 implicated in an increase in FVP, networking, and queuing latency 316 can be identified as a target for one or more predefined mitigation actions.

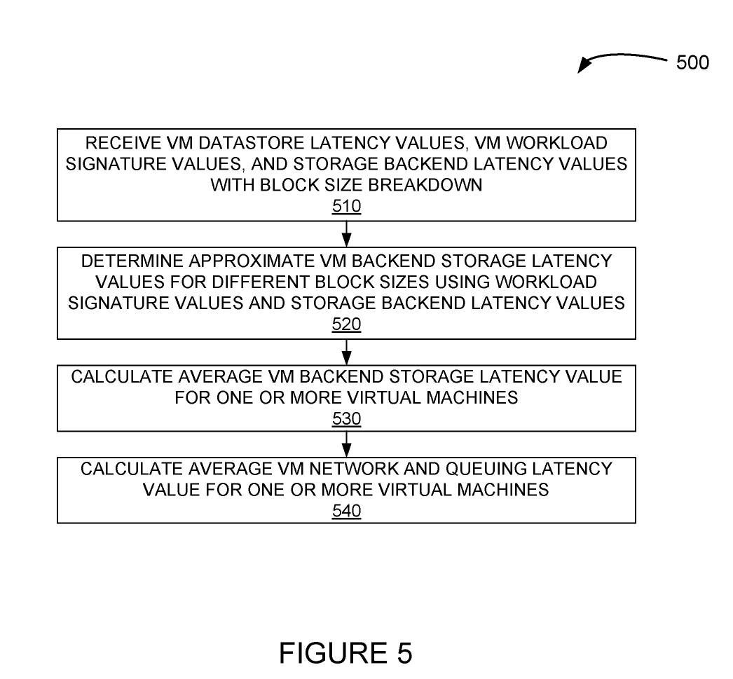

FIG. 5 is a flow chart of a method 500 for estimating latency for a specified virtual machine, according to some embodiments. Although method 500 is described in conjunction with the systems of FIGS. 1-3, any computation system that performs method 500 is within the scope and spirit of embodiments of the techniques disclosed herein. In one embodiment, a storage resource manager, such as storage resource manager 115A, 115B, or 115C of FIG. 1 is configured to perform method 500. Programming instructions for performing method 500 are stored in a non-transitory computer readable storage medium and executed by a processing unit. In one embodiment, the programming instructions comprise a computer program product.

At step 510, the storage resource manager receives VM datastore latency values with block size breakdown (values for different block sizes), VM workload signature values with block size breakdown, and storage backend latency values with block size breakdown.

At step 520, the storage resource manager determines a VM backend storage latency values for different block sizes using workload signature values and storage backend latency values as described herein.

At step 530, the storage resource manager calculates an average VM backend storage latency value for one or more virtual machine 102, as described herein. At step 540, the storage resource manager calculates an average VM FVP, network, and queuing latency value for one or more virtual machines, as described herein.

An average VM backend storage latency value that exceeds a threshold value or increases above a threshold rate can be used to identify a virtual machine 102 involved in excessive latency at the storage backend. The identified virtual machine 102 could be generating workload traffic that is causing a bottleneck at the storage backend comprising the storage media 358. Alternatively, the identified virtual machine 102 could be subjected to other traffic that, in aggregate, causes the identified virtual machine 102 to experience excessive latency. In one embodiment, a mitigation action that improves latency for the identified virtual machine 102 is performed regardless of which other virtual machine or virtual machines are contributing to the excessive latency. An average VM FVP, network, and queuing latency value that exceeds a threshold value or increases above a threshold rate can be used to identify a virtual machine 102 that is involved in the bottleneck within the path of the FVP, network, and queuing latency 316.

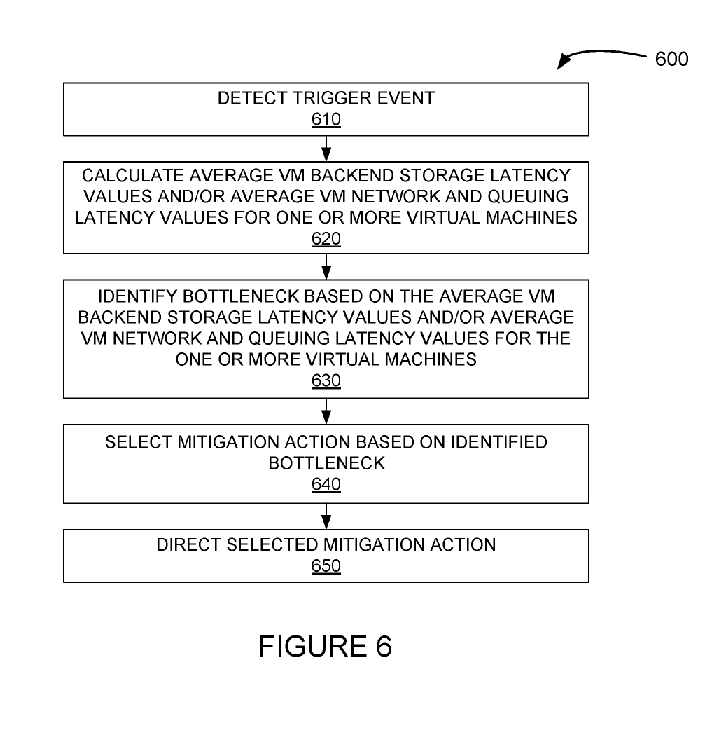

FIG. 6 is a flow chart of a method 600 for managing storage resources using an estimated latency for a specified virtual machine, according to some embodiments. Although method 600 is described in conjunction with the systems of FIGS. 1-3, any computation system that performs method 600 is within the scope and spirit of embodiments of the techniques disclosed herein. In one embodiment, a storage resource manager, such as storage resource manager 115A, 115B, or 115C of FIG. 1 is configured to perform method 600. Programming instructions for performing method 600 are stored in a non-transitory computer readable storage medium and executed by a processing unit. In one embodiment, the programming instructions comprise a computer program product. In one embodiment, method 600 is performed periodically over time (e.g. as a loop) at a time interval specified as a diagnostics window. At each diagnostics window, a mitigation action can be selected and performed. In certain embodiments, a system administrator specifies the time interval.

At step 610, the storage resource manager detects a trigger event, such as a latency increase observed in one or more portions of environment 100 of FIG. 1, or a timer indicating that a time interval for a diagnostics window has completed. At step 620, the storage resource manager calculates average VM backend storage latency values and/or average VM FVP, network, and queuing latency values for one or more virtual machines 102. In certain embodiments, the one or more virtual machines 102 include each virtual machine executing within computer systems 108 and any additional applications generating workload traffic targeting storage system 112. In one embodiment, step 620 comprises method 500.

At step 630, the storage resource manager identifies a bottleneck based on the average VM backend storage latency values and/or average VM FVP, network, and queuing latency values for the one or more virtual machines. More specifically, an increase in average VM backend storage latency values can indicate a bottleneck at the storage media 358 of the storage system 112. An increase in average VM FVP, network, and queuing latency values can indicate a bottleneck between the hypervisor 104 and a storage system side of the storage queues 354. The bottleneck may indicate host queues 352 are too small or one or more virtual machines 102 are generating more workload than the network 116 and/or storage system 112 can service. Of course, other bottlenecks may exist and/or coexist with the two specific bottlenecks implicated by an increase in average VM backend storage latency and/or average VM FVP, network, and queuing latency.

At step 640, the storage resource manager selects a mitigation action based on the identified bottleneck. In one embodiment, if the identified bottleneck is the storage backend/storage media 358, then a mitigation action is selected to include activating caching (using FVP 350) and/or moving a target datastore 356 to a different storage system 112. For example, if the target datastore 356 is receiving a disproportionate amount of workload traffic and consequently exhibiting large latency, then caching workload from one or more virtual machines 102 responsible for generating the workload can reduce workload arriving at the target datastore 356 and reduce associated backend latency for the target datastore 356, and potentially other datastores 356 sharing common storage media 358 with the target datastore 356. Continuing the example, moving the target datastore 356 to a different storage system can reduce interference with other datastores 356 and/or provide an operating environment having a lower overall utilization.

In one embodiment, if the identified bottleneck is the path associated with FVP, network, and queuing latency 316, then a mitigation action is selected to include increasing queue depths at host queues 352 and/or storage queues 354 and/or throttling back one or more virtual machines 102 implicated in causing an FVP, network, and queuing bottleneck.

In other embodiments, if the identified bottleneck is a host latency 310 bottleneck, then one or more virtual machines 102 implicated in generating excessive traffic, excessive CPU or memory utilization (e.g., at storage controller 210 of FIG. 2), or causing interference can be migrated to a different computing system.

In another embodiment, if one or more virtual machines 102 are generating disproportionately intensive workload, then caching can be activated for one or more of the virtual machines 102, one or more of the virtual machines 102 can be migrated to a different computing system 108, and/or a heavily targeted datastore 356 can be moved to a different storage system 112.

At step 650, the storage resource manage directs the selected mitigation action in response to the bottleneck being identified. In one embodiment, directing the selected mitigation action includes causing one or more of the hypervisor 104, cache system 110, and host operating system 106 to: perform a virtual machine migration (e.g., using VMware vMotion) to move the virtual machine 102 to a different computing system 108, reconfigure FVP 350 and/or cache system 110 to enable caching for a specified virtual machine 102; reconfigure host queues 352 and/or storage queues 354 to provide additional queue depth; reconfigure hypervisor 104 to throttle a virtual machine 102; or move a datastore 356 (or other storage resource 222) to a different storage controller 210 or a different storage system 112.

In one embodiment, method 600 is repeated at a specified time interval (diagnostic window).

In summary, a technique for estimating latency for requests generate by a specified virtual machine is disclosed. The technique involves determining approximate latency values for different block sizes at a given system stage using workload signature values measured at the virtual machine and overall block size latency values measured at the system stage. A weighted sum latency attributable to the virtual machine for the system stage is calculated as a sum of products, wherein each product term is calculated by multiplying a workload signature value for a block size by an overall measured latency value for the blocks size. An average VM backend storage latency value, and an average VM FVP, network, and queuing latency value, neither of which is not conventionally observable, may be estimated using the present techniques. The average VM backend storage latency value and an average VM FVP, network, and queuing latency value provide an end-to-end measure of storage latency in a computing environment. In one embodiment, a bottleneck is identified in the computing environment and, based on the location of the bottleneck; in response to identifying the location of the bottleneck, a mitigation action is taken to improve system performance.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
calculating, by a storage resource manager, an average virtual machine (VM) latency value for a system stage, wherein calculating the average VM latency value comprises:
determining VM latency values for different block sizes using workload signature values for the block sizes and average latency values for the block sizes; and
calculating a sum of products using the VM latency values for different block sizes and the workload signature values for the block sizes as product terms;
identifying, by the storage resource manager, that the system stage is a bottleneck in response to calculating the average VM latency value;
selecting, by the storage resource manager, a mitigation action based on the identified system stage; and
directing, by the storage resource manager, the mitigation action in response to the bottleneck being identified.

2. The method of claim 1, wherein the system stage includes one of a storage backend stage and a flash virtualization platform (FVP), network, and queuing stage.

3. The method of claim 1, wherein determining the VM latency values for different block sizes comprises assigning a VM latency value for a first block size to zero when a workload signature value for the first block size is equal to zero, and assigning the VM latency value for the first block size to an average latency value for the first block size when a workload signature value for the first block size is not equal to zero.

4. The method of claim 3, wherein the VM latency values are VM backend storage latency values and the average latency value for the first block size is an average backend latency value for the first block size.

5. The method of claim 1, wherein determining the VM latency values for different block sizes comprises assigning a VM backend storage latency value for a first block size to zero when a workload signature value for the first block size is equal to zero, assigning the VM backend storage latency value for the first block size to a storage backend latency value for the first block size when a workload signature value for the first block size is not equal to zero, and subtracting the VM backend storage latency value from a VM datastore latency value for the first block size.

6. The method of claim 5, wherein the VM latency values are VM FVP, network, and queuing latency values.

7. The method of claim 1, wherein selecting a mitigation action comprises selecting a datastore move in response to identifying the storage backend state is the bottleneck.

8. The method of claim 1, wherein selecting a mitigation action comprises selecting a cache activation for a virtual machine in response to identifying a storage backend stage is the bottleneck.

9. The method of claim 1, wherein selecting a mitigation action comprises selecting a queue depth increase in response to identifying an FVP, network, and queuing stage as the bottleneck.

10. The method of claim 1, wherein selecting a mitigation action comprises selecting a virtual machine migration in response to identifying an FVP, network, and queuing stage as the bottleneck.

11. The method of claim 1, wherein selecting a mitigation action comprises selecting a cache activation for a virtual machine in response to identifying an FVP, network, and queuing stage as the bottleneck.

12. The method of claim 1, wherein the workload signature values for the block sizes and average latency values for the block sizes are measured during a measurement time period.

13. An apparatus, comprising:
a processing unit in communication with a storage controller, the processor configured to:
calculate an average virtual machine (VM) latency value for a system stage, wherein to calculate the average VM latency value, the processing unit is configured to:
determine VM latency values for different block sizes using workload signature values for the block sizes and average latency values for the block sizes; and
calculate a sum of products using the VM latency values for different block sizes and the workload signature values for the block sizes as product terms;
identify that the system stage is a bottleneck in response to calculating the average VM latency value;
select a mitigation action based on the identified system stage; and
direct, by the storage resource manager, the mitigation action in response to the bottleneck being identified.

14. The apparatus of claim 13, wherein the system stage includes one of a storage backend stage and a flash virtualization platform (FVP), network, and queuing stage.

15. The apparatus of claim 13, wherein to determine the VM latency values for different block sizes, the processing unit is configured to assign a VM latency value for a first block size to zero when a workload signature value for the first block size is equal to zero, and assign the VM latency value for the first block size to an average latency value for the first block size when a workload signature value for the first block size is not equal to zero, wherein the VM latency values are VM backend storage latency values and the average latency value for the first block size is an average backend latency value for the first block size.

16. The apparatus of claim 13, wherein to determine the VM latency values for different block sizes, the processing unit is configured to assign a VM backend storage latency value for a first block size to zero when a workload signature value for the first block size is equal to zero, assign the VM backend storage latency value for the first block size to a storage backend latency value for the first block size when a workload signature value for the first block size is not equal to zero, and subtract the VM backend storage latency value from a VM datastore latency value for the first block size, wherein the VM latency values are VM FVP, network, and queuing latency values.

17. The apparatus of claim 13, wherein selecting a mitigation action comprises selecting one of a datastore move and a cache activation for a virtual machine in response to identifying the storage backend state is the bottleneck.

18. The apparatus of claim 13, wherein selecting a mitigation action comprises selecting one of a queue depth increase, a virtual machine migration, and a cache activation for a virtual machine in response to identifying an FVP, network, and queuing stage as the bottleneck.

19. The apparatus of claim 13, wherein the workload signature values for the block sizes and average latency values for the block sizes are measured during a measurement time period.

20. A non-transitory computer readable storage medium, including programming instructions stored therein that, when executed by a processing unit, cause the processing unit to:
calculate an average virtual machine (VM) latency value for a system stage, wherein to calculate the average VM latency value, the processing unit is configured to:
determine VM latency values for different block sizes using workload signature values for the block sizes and average latency values for the block sizes; and
calculate a sum of products using the VM latency values for different block sizes and the workload signature values for the block sizes as product terms;
identify that the system stage is a bottleneck in response to calculating the average VM latency value;
select a mitigation action based on the identified system stage; and
direct, by the storage resource manager, the mitigation action in response to the bottleneck being identified.
